(19) United States
(12) Patent Application Publication
(10) Pub. No.: US 2015/0096298 A1
(43) Pub. Date: Apr. 9, 2015

(54) PRESSURE POWER SYSTEM

(71) Applicants: Bruce I. Benn, Ottawa (CA); Jean Pierre Hofman, Frejus (FR)

(72) Inventors: Bruce I. Benn, Ottawa (CA); Jean Pierre Hofman, Frejus (FR)

(21) Appl. No.: 14/403,326

(22) PCT Filed: May 24, 2013
(86) PCT No.: PCT/IB2013/001309

§ 371 Date: Nov. 24, 2014

(30) Foreign Application Priority Data
May 24, 2012 (CA) 2778101

(51) Int. Cl. F02G 1/044; F03G 6/00; F03G 7/04; F02G 1/055

(52) U.S. Cl. CPC F02G 1/044; F02G 1/055; F03G 6/00; F03G 7/04
USPC 60/641.2; 60/525; 60/641.8

(57) ABSTRACT

The invention relates to energy conversion and generation systems, and more specifically, to a system and method of generating and converting energy by way of a pressure differential in a working fluid. A Pressure Power System is described comprising a cold sub-system, a warm sub-system, a work extraction system, and a hydraulic pump arranged in a closed loop. The cold sub-system and the warm sub-system are respectively maintained at lower and higher temperatures relative to one another, so that a Working Fluid circulated through the closed loop by the pump, will have different equilibrium vapor pressures in the two sub-systems. The different respective state functions of the Working Fluid results in two different levels of elastic potential energy, and subsequently, a pressure differential between the two sub-systems. A work extraction system is positioned between the two sub-systems to convert the elastic potential energy/pressure differential into useful kinetic energy.

### FIELD OF INVENTION

The present invention relates to energy conversion and generation systems, and more specifically, to a system and method of generating and converting energy by way of a pressure differential in a working fluid.

### BACKGROUND OF THE INVENTION

Despite efforts to the contrary, mankind continues to consume more and more energy globally. As a result of concerns about global warming, pollution, diminishing availability of fossil fuels and the high cost of energy in general, efforts are being made to provide clean, renewable and less expensive sources of energy.

Although some sources of clean energy are available, such as wind and solar energy sources, there are other sources of energy that are still largely unexploited, such as waste heat. For example, many power generation systems use steam turbines without extracting valuable energy in the waste steam.

As well, many of the known power generation systems are only practical and efficient if they are built to a very large scale.

There is therefore a need to provide an improved method and system of generating (and converting) energy that is clean, cost effective, efficient, and can be deployed in various sizes, including small systems.

### SUMMARY OF THE INVENTION

It is an object of the invention to provide an improved method and system for generating and converting energy.

This document describes a system, (i.e. the “Power Generation by Pressure Differential” referred hereunder as the “Pressure Power System”), presenting different state functions⁽¹⁾ in a “cold sub-system” versus a “warm sub-system”, which enables the exploitation of the properties of a Working Fluid⁽²⁾, made of a compound substance, often organic, characterized by a low Normal Boiling Point (also referred to as “N.B.P.”)⁽³⁾, to convert energy and to extract work.

Per se, in a Pressure Power System, when a Working Fluid is stored separately, at different Ambient Temperatures⁽⁵⁾ within two separate closed sub-systems principally comprised each of a storage container, the state function of these independent thermodynamic sub-systems differs, causing the fluid to vaporize partially under different conditions, corresponding to two different states of matter of the substance. In each sub-system, said vaporization results in particular equilibrium vapor pressures of the fluid⁽⁹⁾, which correspond to different Ambient Pressures⁽⁸⁾ creating a pressure differential, which is exploited for extracting work.

The concept of the Pressure Power System relies on a few basic function principles, based on well-known Working Fluid's physics. They depend mainly on the Working Fluid's substance, which determines its physical properties of:
1. Volatility
2. Expansion factor
3. Vapor/Liquid Equilibrium
4. Free Expansion
5. Condensation
6. Normal State Function
7. Critical point

The above function principles quantify the state functions respectively applicable in the cold and warm sub-systems, which are directly related to the nature of the Working Fluid's substance and among others to the physical properties resulting from its volatility. They determine the equilibrium vapor pressures which creates the pressure differential between the two sub-systems that may be exploited to extract work.

Within each sub-system of the Pressure Power System, because the equilibrium vapor pressure of the Working Fluid depends on said volatility factor, which does not vary linearly with the temperature, the state function W=PV (pressure multiplied by volume) must also consider the related Ambient Temperature. To simplify the reading of this document, in the state function W=PV:
PV is regarded as the internal energy of the sub-system. The process of vaporization transforms some of said internal energy into another form referred to in this document as the “Elastic Potential Energy”⁽⁷⁾, usually dimensioned in Joules. (See example of Freon R-410A as shown in FIGS. 5 and 6),
W is considered as the corresponding extractable work, which is then usually dimensioned in Watts (see FIGS. 5 and 7).

Consequently, the application path of the Pressure Power System will be represented by an apparatus comprising a cycle where a Working Fluid circulates in a closed loop between two sub-systems, wherein the fluid is stored separately and is respectively maintained at lower and higher Ambient Temperature. Because the configuration results in state functions being different in each sub-system, which correspond to different levels of vaporization, it causes the gaseous part of the fluid (called “saturated vapor”) to present different equilibrium vapor pressures, thereby causing a pressure differential between the cold sub-system and the warm sub-system, which is exploited to extract work.

Like a battery, the Pressure Power System is engineered as a device consisting of two thermodynamic cells which enables the conversion of stored elastic potential energy into mechanical energy to become a common power source for many household and industrial applications.

Accordingly, the practical application of the Pressure Power System (i.e. the “Pressure Power Unit”, whose embodiment is described in a separate patent filed under Applicant Serial No. PCT/CA2013/xxxxx, incorporated herein by reference) targets principally the extraction of work, which can be, but is not limited to being, an industrial facility such as a power station (also referred to as a generating station, power plant or powerhouse) enabling the generation of electricity.

A major difference of a Pressure Power System compared to other thermodynamic systems (e.g. Rankine Cycles) is based on the fact that the pressure differential does not result from the heating of vapor over the critical point of the Working Fluid, (for example, at temperatures ranging over 300° C./540° F. and even over 500° C./930° F.) but from the natural state of matter of the substance at two different states of phase transition, below its critical point, at Ambient Temperatures generally ranging at up to about 20 to 30° C. (68-86° F.). Therefore, the Ambient Pressures involved are exploited in a range of 1 to 64 bars, which is smaller than prior art systems where ‘de facto’ most of the energy of vaporization of the Working Fluid is consumed and somewhat lost by a boiler. This enables the system of the invention to produce power entirely by exploiting only renewable energy sources (e.g. the thermal energy from the surrounding atmosphere).

Of course, to achieve said performance, the work extraction process must be designed accordingly to exploit large volumes of low to medium pressurized vapor rather than high pressure steam flows.

The structural design of the Pressure Power Unit comprises mainly three specific components, respectively performing the above said application path:
The harnessing and/or recovery of the thermal energy found in the surrounding environment of the warm sub-system (i.e. the surrounding temperature⁽⁶⁾) and its transformation into elastic potential energy of a Working Fluid (by vaporization of the substance⁽¹⁰⁾) stored at a specific equilibrium vapor pressure in a component embodying the warm sub-system, according to the Ambient Temperature (i.e. the “Heat Recovery Unit”, described in the co-pending patent application serial number PCT/CA2013/xxxxx, the contents of which are incorporated herein by reference).
The conversion of this elastic potential energy into mechanical energy, i.e. the extraction of work, embodied in a component which exploits, between the warm sub-system and the cold sub-system, the pressure differential resulting from the different equilibrium vapor pressure of the substance as met in said sub-systems (i.e. the “Work Extractor Unit”, described in the co-pending patent application serial number PCT/CA2013/xxxxx, the contents of which are incorporated herein by reference).
The recovery of this vapor into a component embodying the cold sub-system, whereas a lower Ambient Temperature, which corresponds to a lower Ambient Pressure, results in a different equilibrium vapor pressure which enables the liquefaction of the substance⁽¹¹⁾ (i.e. the “Vapor Recovery Unit”, described in the co-pending patent application serial number PCT/CA2013/xxxxx, the contents of which are incorporated herein by reference).

A number of ways for manufacturing these three components will become apparent to anyone with skill in the art and may result in different frameworks or physical embodiments, which enables developing this technology without departing from the fundamental concept of this invention.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The present invention will be further understood from the following detailed description with reference to the drawings in which:

FIG. 1 presents a concept diagram of a Pressure Power System in an embodiment of the invention;

FIG. 2 presents a working process diagram of a Pressure Power System in an embodiment of the invention;

FIG. 3 presents a pressure/temperature graph of exemplary working fluids in an embodiment of the invention;

FIG. 4 presents a pressures/temperatures chart of exemplary working fluids in an embodiment of the invention;

FIG. 5 presents a state function chart of refrigerant (R-410A) as an exemplary working fluid in an embodiment of the invention;

FIG. 6 presents an elastic potential graph of refrigerant (R-410A) as an exemplary working fluid in an embodiment of the invention;

FIG. 7 presents an extractable work graph of refrigerant (R-410A) as an exemplary working fluid in an embodiment of the invention; and

FIG. 8 presents a block diagram of an exemplary embodiment of the Pressure Power System.

### BRIEF DESCRIPTION OF PREFERRED EMBODIMENTS OF THE INVENTION

### Working Fluid's Substance

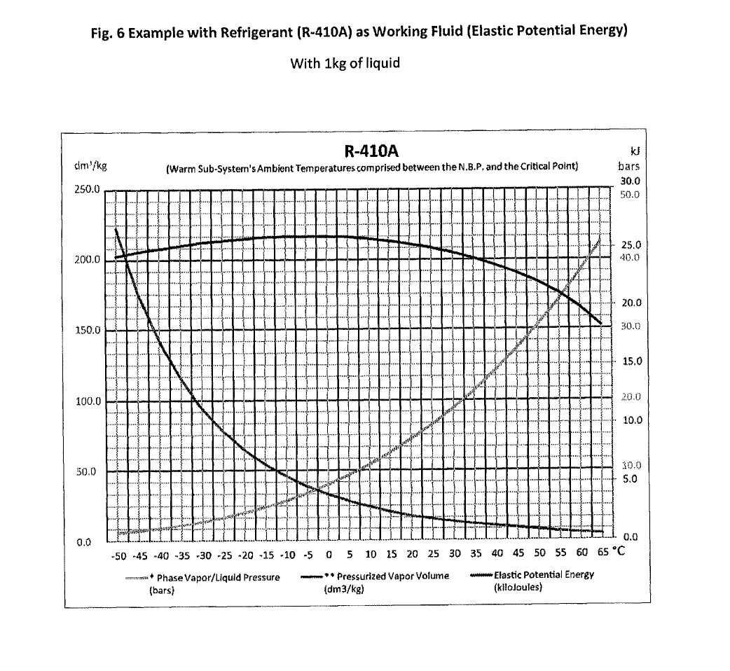

Ambient Temperature & Ambient Pressure Considerations
As seen above the Pressure Power System mainly relies on the performance of the following three processes:
   the vaporization
   the work extraction
   the liquefaction
All of these result from the Ambient Temperature and Ambient Pressure values met in both cold and warm sub-systems. Therefore, the conceptual pattern of the Pressure Power System considers primarily the working conditions of each process and the constraints that they present:
   the Ambient Temperature exploitable within the warm sub-system, which often should correspond to the surrounding temperature and should try to avoid the use of any form of external heating which consumes energy resources,
   the resulting Ambient Pressure within the warm sub-system, which must be sufficient to create enough elastic potential energy,
   the surrounding temperature, exploitable to warm the best range of Ambient Temperatures within the warm sub-system for generating the most efficient quantities of elastic potential energy (e.g. between 0° C. and 55° C. with R-410A per FIGS. 6 and 7), thereby improving the performances of the Pressure Power System, and
   the Ambient Pressure to maintain within the cold sub-system, which represents the possible pressure differential but also, consequently, the Ambient Temperature to use for the vapor recovery process and its liquefaction by free expansion and condensation.
Also, the conceptual pattern of the Pressure Power System must consider the substance of the Working Fluid, whose N.B.P. and reference values result in different state functions of the system. For example:
   the liquid/gas volume equivalent (the expansion factor) of the Working Fluid within both warm and cold sub-systems, which determines the volumes of fluid to circulate in the system for raising sufficient conversion of energy (extraction of work), and
   the vapor pressure equilibrium which may be exploited in both cold and warm sub-systems.
Consequently, these considerations also rely on the substance which the Working Fluid is made of, as developed hereunder.

Choice of the Substance
Because the Working Fluid only fills the warm and cold sub-systems partially, the different state functions in each of these warm and cold sub-systems naturally tend to a different equilibrium vapor pressure of the substance whereas each pressurized vapor is in specific level of thermodynamic equilibrium with its liquid phase, thereby enabling the presence of the two states of matter: gas and liquid.
   In the cold sub-system: The Boiling Point of the Working Fluid, corresponding to the working Ambient Temperature within the cold sub-system, determines the reference level of the Pressure Power System (the “Normal State Function” of the system). Preferably, the working Ambient Temperature in the cold sub-system should be as close as possible to the N.B.P. of the substance because it enables a larger pressure differential with the warm sub-system, per se more extractable work.
   In the warm sub-system: The surrounding conditions of heat determine the working Ambient Temperature of the warm sub-system and consequently its working Ambient Pressure. For better performance of the Pressure Power System, the working Ambient Temperature of the warm sub-system should be as close as possible to the critical point of the substance.
   In the work extraction process: The resulting pressure differential between the warm sub-system and the cold sub-system thus quantifies the amount of exploitable elastic potential energy and qualifies the exploitable energy efficiency of the Pressure Power System.

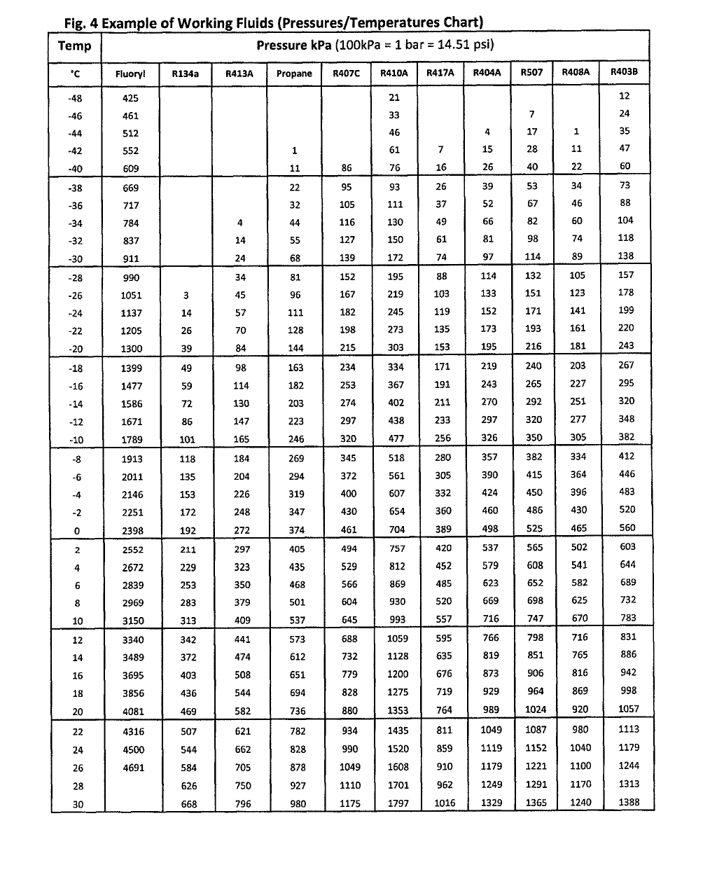

However, each substance which could be chosen for use as the Working Fluid in the Pressure Power System presents different criteria of state of matter⁽¹⁴⁾ related to its temperature/pressure behavior. Hereunder, the example of “Pressure/Temperature chart” (see FIG. 4) provides the figures for some Working Fluids which can be used in the Pressure Power System, indicating the Ambient Temperatures and their respective Ambient Pressures at which the Pressure Power System may operate.

Therefore, the choice of the substance is primordial and must be made accordingly to the working conditions of Ambient Temperature which may be maintained in the cold and warm sub-systems.

As examples, most of the references made in this document are generally based on the use of R-410A as the Working Fluid and figure models where the surrounding temperatures of the warm sub-system vary so that it enables maintaining the Ambient Temperature within the warm sub-system around the ISMC and where the cold sub-system is maintained at Ambient Temperatures between −40° C. (−40° F.) and −30° C. (−22° F.).

### Working Fluid's Physics

As seen above, the Pressure Power System is conditioned by the Working Fluid's state of matter of the Working Fluid in the cold sub-system versus in the warm sub-system which state functions rely upon, among others, the volatility and expansion factor of the Working Fluid as well as its Normal Boiling Point and critical point:

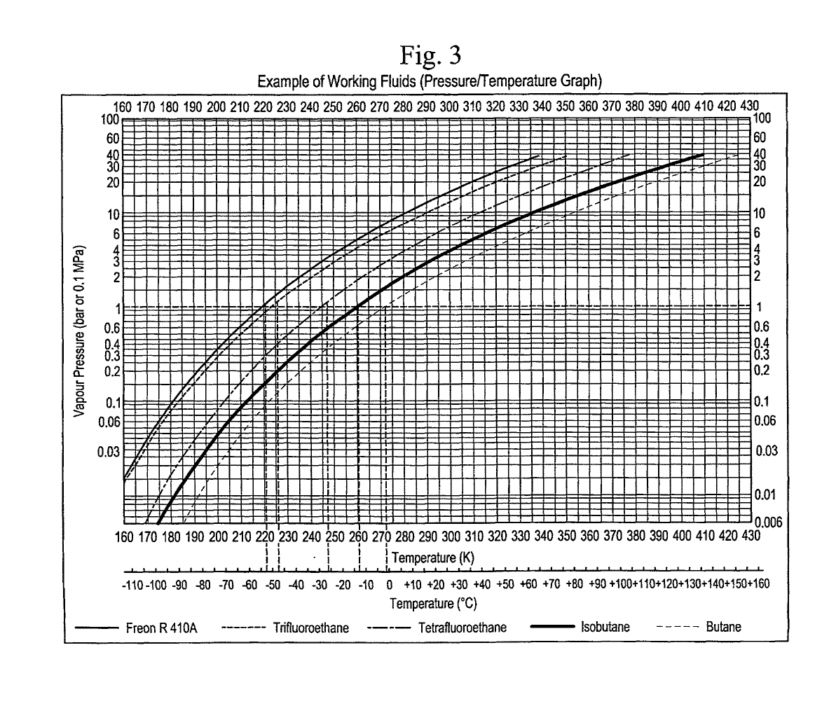

Volatility
The Working Fluid's state of matter is mainly determined by the tendency of the substance to vaporize, known as its volatility⁽¹³⁾, and is related directly to the substance's equilibrium vapor pressure.
At a given temperature, the state function of the system determines the equilibrium vapor pressure of a fluid or compound substance stored in a determined volume, at which its gaseous phase⁽¹²⁾ (“vapor”) is in equilibrium with its liquid phase.
Comparing two thermodynamic systems, considered as independent closed sub-systems, where the stored Working Fluid is the same but at two different Ambient Temperatures (thus representing different state functions), the volatility (or equilibrium vapor pressure), which is needed in each sub-system to overcome the Ambient Pressure and to lift the liquid to form vapor, is different.
A substance with a high vapor pressure at normal temperatures is often referred to as volatile. The higher the volatility, the higher the vapor pressure of a liquid at a given temperature and the lower the normal boiling point of the liquid. Such property is generally represented by a vapor pressure chart (see FIGS. 3 and 4) which displays the vapor pressure dependency of liquid substances as a function of their Ambient Temperature.

Expansion Factor
In the warm sub-system, the thermal energy of the surroundings is transferred into the liquid Working Fluid, more generally by heat exchange, which causes the liquid to vaporize and results in a significant augmentation in volume:
   When expelled in an open space at ISMC atmospheric pressure equivalent⁽¹⁵⁾, the volume expansion of the gaseous form of the various possible Working Fluids generally corresponds to an expansion factor ranging approximately 200 to 400 times the normal volume of their liquid form. For example, at ISCM conditions:
      for R-410A the expansion factor is about 256 times,
      for Propane the expansion factor is about 311 times, and
      for Carbon Dioxide the expansion factor is about 845 times.
   When confined in a limited volume, such process results in the increase of the vapor's pressure head, thereby transforming the internal energy into elastic potential energy. This controlled change of the state of matter (phase transition) causes only part of the liquid to be transformed into gas, as explained above, by balancing the equilibrium vapor pressure of the Working Fluid within its container.

In the Pressure Power System, the warm sub-system generally contains a pre-determined volume of Working Fluid, which should be maintained constant (by means of the vacuum pump system) so that it may preserve stable the state functions of the system.

The expansion of the Working Fluid in its gaseous phase, resulting from the vaporization process, enables progressively to increase the effective exploitable volume of the pressurized gas but is then reduced, in turn, by the work extraction process which transforms the pressure differential into kinetic energy (i.e. into work), which enables the system to conserve its state functions' equilibrium.

The conceptual pattern of the Pressure Power System also is based on the Vapor/Liquid Equilibrium:

Vapor/Liquid Equilibrium
The property of vapor pressure or equilibrium vapor pressure of a substance represents the pressure exerted by a vapor in thermodynamic equilibrium with its condensed phase at a given temperature in a closed system, per se when a Working Fluid is stored in a container, the capacity of which is larger than the liquid fluid volume equivalent but smaller than the vapor pressure volume equivalent, at the particular conditions of Temperature/Pressure met in the sub-system. Consequently, in the container the Working Fluid naturally vaporizes/condenses until “saturated” at its Vapor/Liquid Equilibrium.
The equilibrium vapor pressure is an indication of the liquid's evaporation rate, which increases non-linearly with temperature, according to the Clausius-Clapeyron relation⁽¹⁶⁾. It relates to the tendency of particles to escape from the liquid (the volatility).
In both sub-systems, the state functions determine how the Working Fluid's substance normally equilibrates the volumes of pressurized vapor and liquid. Because the volume of liquid Working Fluid is smaller than the storage capacity of the sub-systems, it occupies only a part of their capacities, the rest being filled with the vapor. In both sub-systems, the Working Fluid naturally finds its pressurized vapor/liquid equilibrium. Should the state function of Ambient Pressure within the sub-system become lower, some liquid automatically vaporizes until the Working Fluid finds its equilibrium vapor pressure, which causes the rest of the storage capacity to be filled with pressurized vapor. Should the state function of Ambient Pressure within the sub-system be higher, some pressurized vapor automatically liquefies.
Because of gravity, the heavier liquid part occupies the bottom of the container device and the lighter pressurized gas is confined to the top; so that:
   in the warm sub-system, the pressurized gas may expand in the work extraction device, from the top, and
   in the cold sub-system, the liquid may be pumped out of the bottom and redirected to the warm sub-system.

Free Expansion
In the cold sub-system, free expansion is an irreversible process in which a gas expands into an insulated evacuated chamber (i.e. the expansion chamber), thereby causing its Ambient Pressure to decrease. Real gases experience a temperature change during free expansion and the lower the Ambient Pressure may decrease within a large expansion chamber, then the lower the temperature of the expanded gas declines (at atmospheric pressure the gas temperature possibly diminishes to the Dew Point, per se about its N.B.P.), thereby causing a little phase transition from vapor to liquid.
During free expansion, no work is done by the gas, which means no energy is consumed. The gas goes through states of no thermodynamic equilibrium before reaching its final state, which implies that one cannot define thermodynamic parameters as values of the gas as a whole. For example, the Ambient Pressure changes locally from point to point, and the volume occupied by the gas (which is formed of particles) is not a well defined quantity. This means that the process is naturally balanced by the Ambient Temperature's decline.
This throttling process (also called the “Joule-Thomson effect”⁽¹⁷⁾) is of technical importance, because it represents the main first step for re-liquefying the gaseous Working Fluid in the cool sub-system.

Condensation
The second step to achieve re-liquefaction in the cold sub-system consists of a process of condensation. The cold expanded vapor is pumped out of the expansion chamber and expelled into a condenser preferably by passing through a large number of openings (the gap/cap inlet openings), per se via a series of valves or porous plugs, forcing the vapor to flow through the liquid Working Fluid already stored in said device. For doing so, the pump needs to increase a little the Ambient Pressure of the cold vapor, with a compression factor representing less than 0.2 bar, in order to move it through the inlet openings, which results in the vapor condensation.
Should some residual vapor remain by such active spray system, it will form little bubbles which, when rising to the surface of the stored cold Working Fluid, naturally achieve their condensation process because of the cold Ambient Temperature.
Accordingly, the entire cold sub-system may be self-stabilized at an Ambient Pressure and Ambient Temperature close to the normal state function of the Working Fluid.

Normal State Function
In a Pressure Power System, the reference value is the Normal Boiling Point of the Working Fluid which should represent closely the normal state function within the cold sub-system. Thus, the Working Fluid must be chosen according to the exploitation criteria of the cold sub-system. It is the Ambient Temperature in the cold sub-system which determines the nature of the substance to be selected, for the state function to be as close as possible to the Working Fluid's N.B.P. For example:
   the N.B.P. of R23/Fluoryl corresponds to a temperature of −82.1° C./−115.78 K,
   the N.B.P. of the refrigerant R-410A corresponds to a temperature of −52.2° C./−61.96° F., and
   the N.B.P. of R134A corresponds to a temperature of −26.3° C./−15.34° F.

Critical Point
However, when choosing the Working Fluid one must also refer to its “Critical Point”. Each possible Working Fluid shows a specific state of saturation at a certain boiling point corresponding to a precise critical point of its phase transition at which the liquid/gas phase boundary ceases to exist and the substance is present only in its gaseous form. This limits the maximum temperature/pressure that needs to be attained by the state function of the warm sub-system, per se an Ambient Pressure generally ranging between 32 and 64 bars, and corresponds to the maximum level of Ambient Temperature to maintain in said warm sub-system, as determined by the Temperature/Pressure chart of the Working Fluid's material. For example:
   the Critical Point of R23/Fluoryl corresponds to a pressure of 48.37 bars (701.55 psi) at 25.6° C./78° F.,
   the Critical Point of the refrigerant R-410A corresponds to a pressure of 49.4 bars (716.49 psi) at a temperature of 72.5° C./162.5° F.,
   the Critical Point of R134A corresponds to a pressure of 40.6 bars (588.85 psi) at 100.9° C./213.6° F.).

### Preferred Embodiment of the Design

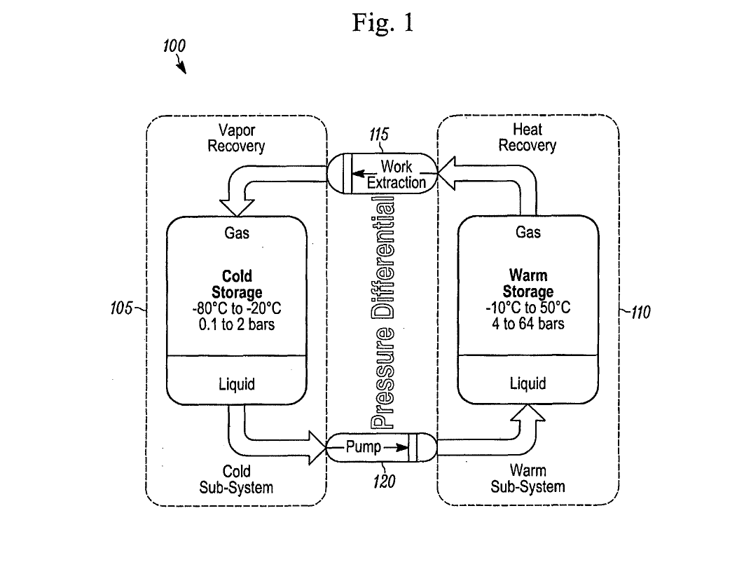

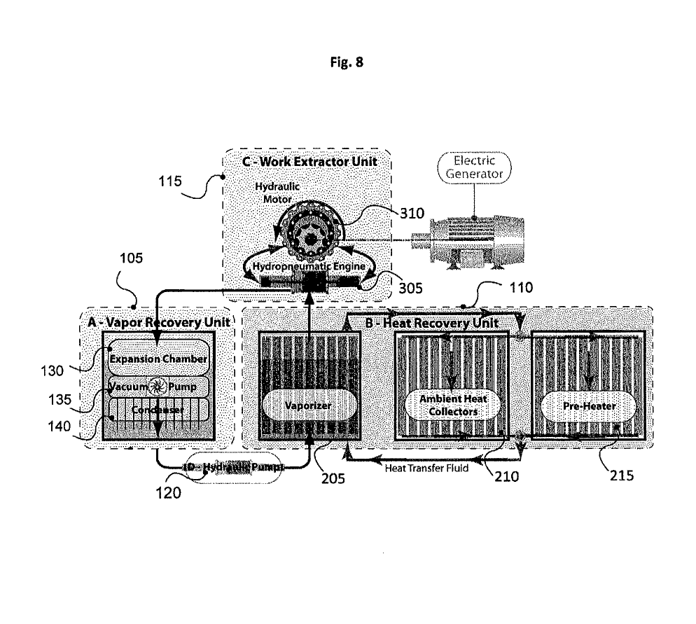

Referring to FIGS. 1 and 8, the conceptual design of the closed loop in an exemplary embodiment of a Pressure Power System 100 comprises a cold sub-system 105 (i.e.: A—the Vapor Recovery Unit), a warm sub-system 110 (i.e.: B—the Heat Recovery Unit), a work extraction process 115 (i.e.: C—the Work Extractor Unit) and a transfer pump 120 (i.e.: D—the Hydraulic Pump).

The Normal State Function in the cold sub-system 105 represents the reference level for the equilibrium vapor pressure of the Working Fluid.

Some of the Working Fluid is permanently stored in the cold sub-system 105, which is maintained constantly at a cold Ambient Temperature generally ranging between −80° C. and −20° C., as close as possible to the fluid substance's N.B.P. According to the state function of the Working Fluid at said Ambient Temperature, the Ambient Pressure of the Working Fluid generally ranges between 0.1 bar and 2 bars of gauge pressure (i.e. the pressure relative to the local atmospheric pressure).

To maintain constantly said cold Ambient Temperature, the cold sub-system 105 preferably comprises:
An expansion chamber 130 enlarging the volumetric efficiency of said cold sub-system 105, thereby enabling the free expansion of the Working Fluid in its gaseous form to about atmospheric pressure and thereby its N.B.P. volume occupancy. This initiates the liquefaction of the vapor;
a vacuum system 135 maintaining the Ambient Pressure of the expansion chamber 130 at about the atmospheric pressure and thereby enabling the cold sub-system 105 to conserve Ambient Temperature conditions at about the dew point of the Working Fluid, while compressing a little the vapor/liquid mixture expelled into the condenser 140;
a condenser 140, functioning as the storage device wherein the remaining part of the gaseous Working Fluid liquefies, thereby enabling the Working Fluid to keep constant its vapor/liquid equilibrium at an Ambient Temperature a little above its N.B.P. This achieves the liquefaction of the vapor.
When in operation, it is sufficient for the Pressure Power System 100 to maintain the lowest possible Ambient Pressure, thereby naturally enabling attainment of the cold Ambient Temperature simply by cooling, which results from the free expansion process.
When the system stops working for any reason, the cold sub-system 105 requires an external cooling device to be enclosed (not shown), to maintain said cold Ambient Temperature, thereby keeping the low Ambient Pressure. When the system stops working for any reason, then the temperature in the cold sub-system will start to increase whereupon the pressure in the cold sub-system also will increase. In this instance the cold sub-system 100 requires an external cooling device to maintain said cold Ambient Temperature, thereby keeping the low Ambient Pressure. Regardless, the cold sub-system should be built to withstand pressures of up to 30 bars for safety reasons, in case the system stops for lengthy periods of time and there is no external cooling device or for any reason the external cooling device is not working.

Warm Sub-System
Some Working Fluid also is stored permanently in the warm sub-system 110, where it is maintained constantly at a higher Ambient Temperature, generally ranging between −10° C. and +80° C. According to its volatility, the Ambient Pressure of the Working Fluid in the warm sub-system generally ranges between 4 and 32 bars of gauge pressure.
Said Ambient Temperature is obtained by heat transfer from the medium available in the surroundings (room, container, building, facility or outdoors), generally by using heat exchangers (i.e.: the Vaporizer) 205 which transform the surrounding thermal energy into the internal energy of the Working Fluid and, in turn, most of said internal energy into elastic potential energy:
   said heat exchanger may be warmed possibly by remote energy sources including, but not limited to, the following group consisting of: thermal solar; geothermal; wind; biomass; fuel cells; water flows such as rivers, sea beds, aquifers or groundwater sources; heat gradient found underground, for example, in mine shafts and in the basements of buildings; commercial or industrial heat recovery systems; greenhouses; and ambient temperature found in the atmosphere not immediately surrounding or in industrial buildings; and
   said heat exchanger may be warmed further by an external heater, possibly fueled by propane, natural gas or another fuel.
Also, one should note that the warm sub-system 110 possibly may collect energy from multiple surrounding heat energy sources, by using Ambient Heat Collectors 210 and/or Pre-Heater(s) 215, which may be located at a distance from the Pressure Power System 100, enabling the exploitation of the Pressure Power System 100 to work as a hybrid working process.

Work Extraction Process
The work extraction process must be designed specially to embody a variable capacity device, such as a Hydropneumatic Engine 305 which may transform pressure into motion of a hydraulic motor 310. Thereby, the process harnesses and transforms the pressure differential between the cold sub-system 105 and the warm sub-system 110 by exploiting the expansion of volume resulting from the vaporization of the Working Fluid in the warm sub-system 110, per se the work extraction device 115 converts the elastic potential energy produced within the warm sub-system into kinetic energy. Note of course, that other devices, like turbines, may also be used.

### Working Process

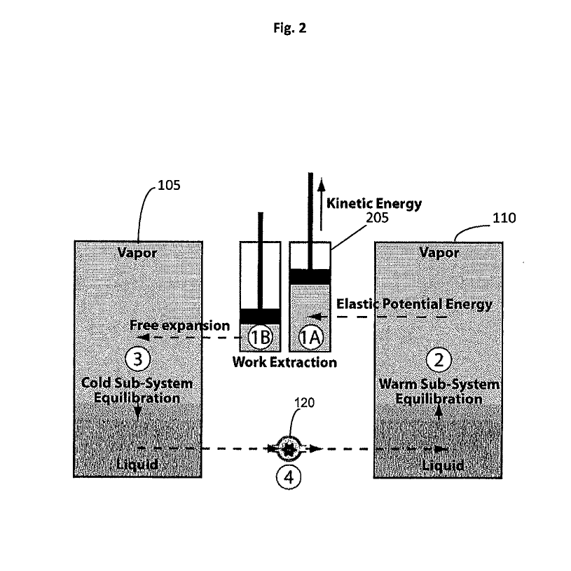

Consequently, the working process of a Pressure Power System consists of four interdependent features (see FIG. 2):

(1) Work Extraction
Circulating the gaseous state of matter of the Working Fluid from the warm sub-system 110, through a work extraction device 115, into the cold sub-system 105 enables transformation of the elastic potential energy, which causes the differential of Ambient Pressures between the warm sub-system 110 and the cold sub-system 105, into kinetic energy, i.e. the work extraction.
Therefore, the transformation of the elastic potential energy into kinetic energy exploits the pressure differential of the gaseous Working Fluid between the warm sub-system 110 and the cold sub-system 105:
   1A) by enabling the Ambient Pressure of the gaseous Working Fluid to exert stress on an expandable pressure device by pushing on and displacing a movable surface (for example, a Work Extractor 205 comprised of a piston in a cylinder);
   1B) by releasing the gaseous Working Fluid into the cold sub-system 105, where it expels by simple free expansion.

(2) Equilibration of the Vapor/Liquid State of Matter in the Warm Sub-System 110
Because the above process modifies the equilibrium vapor pressure in the warm sub-system 110 by diminishing the volume of pressurized vapor versus the volume of liquid, the state function met in the warm sub-system 110 automatically causes the state of matter of the Working Fluid to re-equilibrate by vaporizing part of the liquid into pressurized vapor.
It is noted that the overall volume of Working Fluid in the warm sub-system 110 is diminished temporarily by the quantity of matter used by the work extraction process. This reduction of volume of the Working Fluid also causes the state function to diminish slightly the Ambient Pressure, which results accordingly in a little lower Ambient Temperature.

(3) Equilibration of the Vapor/Liquid State of Matter in the Cold Sub-System
The work extraction process also modifies the equilibrium vapor pressure in the cold sub-system 105 by increasing temporarily the volume of pressurized vapor versus the volume of liquid with the quantity of matter expelled by the work extraction device 115, which causes the state function to increase a little the Ambient Pressure and results accordingly in gaining a little higher Ambient Temperature. Therefore, the state function met in the cold sub-system 105 requires the state of matter of the Working Fluid to be re-equilibrated by liquefying the vapor, which is achieved by the condensation process embodied in the cold sub-system 105.

(4) Re-Initialization
The above features for the work extraction result in a change of the system criteria whereas the original volumes of Working Fluid stored in both warm sub-system 110 and cold sub-system 105 are changed.
For the Pressure Power System to retrieve its basic conditions and to re-initialize the working process, some liquid Working Fluid is pumped from the cold sub-system 105 and is redirected into the warm sub-system 110 via a pump 120 (i.e.: D—a hydraulic pump).

### Working Conditions

Pressure Differential
As seen above, the conceptual design of the Pressure Power System 100 is conceived and designed to exploit in a primary cold sub-system 105 the Normal State Function, which causes a Working Fluid to present a Normal Boiling Point far below the ‘ISMC’ temperature⁽¹⁵⁾ (preferably, but not necessarily, below −20° C.) corresponding to an Ambient Pressure about atmospheric and to re-liquefy.
Then, circulating the liquid substance in a closed loop through the Pressure Power System 100, from this cold sub-system 105, through a secondary warm sub-system 110 where the Ambient Temperature is maintained at about the ‘ISMC’ temperature, causes the state function to vary naturally the volatility of the Working Fluid, thus balancing its elastic potential energy and its equilibrium vapor pressure with the increase of its Ambient Pressure by several bars, thereby generating a pressure differential between the warm sub-system 110 and cold sub-system 105, sufficient to be exploited to extract work.

Exploitable Energy
Because of the volume expansion factor of the Working Fluid, which depends on the substance used as the Working Fluid and which gains about 200 to 400 times, or more, its volume when vaporizing within the warm sub-system 110, the total pressure force exerted by the vapor, when expelled into the work extraction device 205, is about 200 to 400 times greater than the total pressure force needed to pump back the smaller volume of liquid Working Fluid from the cold sub-system 105. Therefore, it enables the Pressure Power System 100 to create more exploitable energy than is required to circulate the Working Fluid back from the cold sub-system 105 to the warm sub-system 110.
Moreover, because the surrounding thermal energy may be regarded as infinite and free, the exploitable energy which results from the transformation of said thermal energy into the elastic potential energy of the Working Fluid, becomes only a matter of dimensions given to the embodiment of the warm sub-system 110 for enabling sufficient heat exchange.

External Energy
The working process of the Pressure Power System 100 shows that the work extraction changes the working conditions of both the cold sub-system 105 and warm sub-system 110:
   In the warm sub-system 110, the Ambient Temperature decreases unless it is re-warmed.
   In the cold sub-system 105, the Ambient Temperature increases unless it is maintained.
Therefore, external energy (i.e. the surrounding thermal energy and the compression work) may be needed to re-equilibrate the Pressure Power System 100 to its basic conditions, thereby determining the nature and the dimensions to be given to the components of the Pressure Power System 100.
Per se, the working conditions represent the efficiency factor of the Pressure Power System 100, which may be computed by the quantification of the different energies involved and their successive transformations, i.e. the analysis of the energy balance throughout the system's circuit:

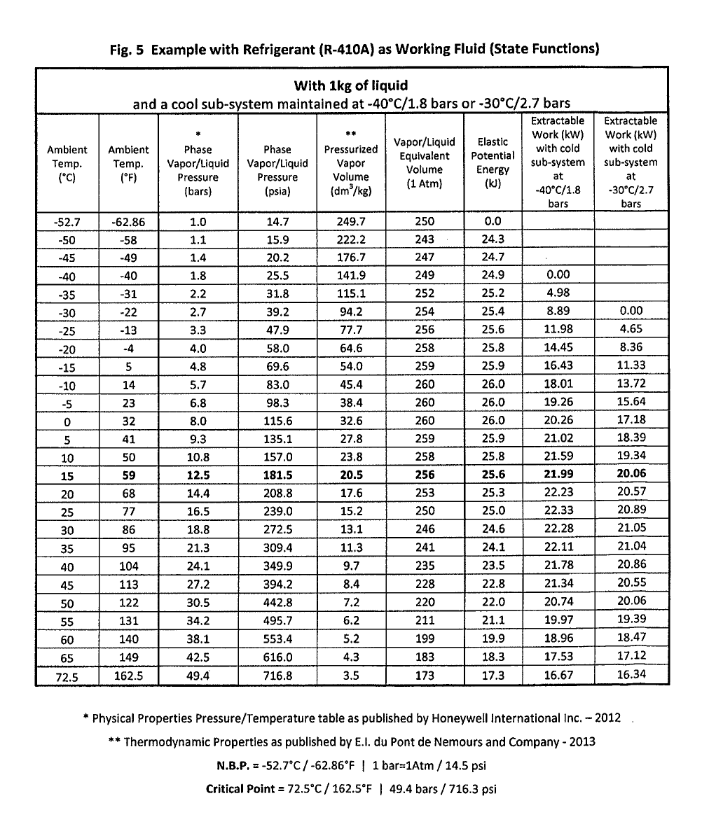

Energy Balance
Considering the example of 1 kg of Working Fluid R-410A (see FIG. 5):

1. Vaporization
Coming from the cold sub-system 105 (e.g. at an Ambient Temperature of −30° C./−22° F.), the cold liquid Working Fluid must be warmed (e.g. by heat exchange which transforms the surrounding thermal energy into internal energy of the Working Fluid) to the working Ambient Temperature of the warm sub-system 110 (e.g. 20° C./68° F.).
The vaporization process transforms some of the internal energy into elastic potential energy. That is, to become saturated vapor, i.e. 17.6 L (62.15 ft³) at 20° C. and 14.4 bars, 1 kg of liquid Working Fluid represents the transformation of 25.3 kJ of internal energy into elastic potential energy, thereby creating a pressure differential.

2. Work Extraction
This pressure differential enables extraction of work. With an Ambient Pressure in the cold sub-system maintained at −30° C., the pressure differential represents 11.7 bars [14.4 bars-2.7 bars] and the 17.6 L of pressurized vapor corresponds to an extractable amount of work which equals 20.57 kW [11.7 bars×17.6 L].

3. Condensation
When the pressurized vapor is expelled out of the work extraction process (e.g. 17.6 L), the free expansion process, which does not require any work, causes the volume to expand (e.g. 94.2 L/3.33 ft³ of saturated vapor at 2.7 bars), thereby causing the Ambient Temperature to decrease naturally to the dew point (e.g. about −30° C. as maintained in the cold sub-system). Note that there is a very little difference between the boiling point and the dew point.
During the second step of the condensation process, work must be done to compress the vapor (e.g. 0.2 bars, which represents 1.9 kW [94.2 L×0.2 bars]), making all of the vapor to be recovered as liquid. This results in very little increase in the Ambient Temperature of the Working Fluid stored in the condenser container, e.g. about 0.2° C. difference compared to the Ambient Temperature within the expansion chamber.

4. Re-Initialization
In the cold sub-system 105, the condensation process results in a significant reduction of the gaseous Working Fluid into liquid, ranging about 200 to 400 times (e.g. at an Ambient Temperature of −30° C. and an Ambient Pressure of 2.7 bars, 1 kg of R-410A in its gaseous phase occupies 94.2 L/3.33 ft³ and represents only about 0.774 L in its liquid phase).
Consequently, to pump this liquid back into the warm sub-system 110 where the Ambient Pressure is greater, the external energy which is required is notably lower than the extracted work. With an Ambient Pressure of 2.7 bars in the cold sub-system 105 and an Ambient Pressure of 14.4 bars in the warm sub-system 110, the work to do may be computed as 0.906 kW [11.7 bars×0.774 L].

### EXAMPLES

By circulating 1 kg (2.2 lb) of liquid refrigerant fluid R-410A (see FIGS. 5, 6 and 7):

In the Cold Sub-System=−40° C./−40° F.
Maintained at an Ambient Pressure of 1.76 bars (1 bar=100 kPa or kilopascal=14.5 psi or pound per square inch):
   At said Ambient Pressure, the free expansion process has caused the state function of the Working Fluid to cool down naturally, thereby enabling the equilibrium vapor pressure of the substance to be maintained at an Ambient Temperature of −40° C./−40° F.,
   In its pressurized vapor form, the fluid corresponds to a volume of 141.9 L (5.01 ft³),
      a) In the warm sub-system=20° C./68° F.
         Maintained at an Ambient Temperature of 20° C./68° F.:
         At said Ambient Temperature, the state function of the Working Fluid causes the equilibrium vapor pressure of the substance to correspond to an Ambient Pressure of 14.43 bars,
         In its pressurized vapor form, the fluid corresponds to a volume of 17.6 L (0.62 ft³),
         The state function PV in the warm sub-system represents an elastic potential energy equivalent to:

17.6 L×14.43 bars=25.4 kJ
The two sub-systems present a pressure differential of 12.67 bars which may be exploited to extract work from the 17.6 L of pressurized vapor:

17.6 L×12.67 bars=22.23 kW
which represents for the Pressure Power System a possible efficiency ratio of 87.5% (without mechanical losses)
b) In the warm sub-system=30° C./86° F.
   Maintained at an Ambient Temperature of 30° C./86° F.:
   the Ambient Pressure is 18.83 bars,
   the pressurized vapor has a volume of 13.1 L (0.46 ft³),
   the elastic potential energy is equivalent to:

13.1 L×18.83 bars=24.7 kJ
the pressure differential is 17.07 bars and the extractable work, from 13.1 L of pressurized vapor, equals:

13.1 L×17.07 bars=22.28 kW
which represents for the Pressure Power System a possible efficiency ratio of 90.2% (without mechanical losses)

In the Cold Sub-System=−30° C./−22° F.
Maintained at an Ambient Pressure of 2.7 bars:
   At said Ambient Pressure, the sub-system equilibrates at the Ambient Temperature of −30° C./−22° F.,
   In its pressurized vapor form, the fluid corresponds to a volume of 94.2 L (3.33 ft³),
      a) In the warm sub-system=20° C./68° F.
         Maintained at an Ambient Temperature of 20° C./68° F.:
         the Ambient Pressure is 14.43 bars,
         the pressurized vapor has a volume of 17.6 L (0.62 ft³),
         the elastic potential energy is equivalent to:

17.6 L×14.43 bars=25.4 kJ
the pressure differential is 11.73 bars and the extractable work, from 17.6 L of pressurized vapor, equals:

17.6 L×11.73 bars=20.57 kW
which represents for the Pressure Power System a possible efficiency ratio of 81% (without mechanical losses)
b) In the warm sub-system=30° C./86° F.
   Maintained at an Ambient Temperature of 30° C./86° F.:
   the Ambient Pressure is 18.83 bars,
   the pressurized vapor has a volume of 13.1 L (0.46 ft³),
   the elastic potential energy is equivalent to:

13.1 L×18.83 bars=24.7 kJ
the pressure differential is 16.13 bars and the extractable work, from 13.1 L of pressurized vapor, equals

13.1 L×16.13 bars=21.05 kW
which represents for the Pressure Power System a possible efficiency ratio of 85.2% (without mechanical losses)

Efficiency

As shown in FIG. 7, for each kilogram of Freon R-410A, the Pressure Power System 100 enables exploitation of a large part of the elastic potential energy contained in the warm sub-system 110 to extract work (i.e. to produce power). However, because the state function met within the warm sub-system 110 determines the variable maximum of elastic potential energy, the Pressure Power System 100 may only extract work within these limits.

Below and beyond certain values, one should consider that the efficiency factor for work extraction is no more favorable and should adjust accordingly the parameters by designing the system to benefit from the best conditions, per se by using a Working Fluid's substance which fits the best with the exploitation criteria of Ambient Temperature in both warm and cold sub-system.

In the example above using R-410A, when:
the cold sub-system 105 is maintained at about −40° C., the Ambient Temperature in the warm sub-system 110 should be ranging between 0° C. and 55° C.,
the cold sub-system 105 is maintained at about −30° C., the Ambient Temperature in the warm sub-system 110 should be ranging between 15° C. and 50° C.
to enable extraction of work over 20 kW/kg.

Efficiency Ratio
As seen above in this example, the Pressure Power System 100 offers the following energy balance (without computing the possible mechanical losses) for each kg of R-410A which is processed:
   an exchange of 25.3 kJ of thermal energy into internal energy, which in turn is transformed into elastic potential energy,
   an extracted work equaling 20.57 kW, but
      a compression work representing about 1.9 kW,
      a circulation pumping work equivalent to 1.115 KW
   makes the effective exploited work to be computed as about 17.55 kW.
Consequently, the energy balance shows an efficiency ratio of 69.4%.

### CONCLUSIONS

One or more currently preferred embodiments have been described by way of example. It will be apparent to persons skilled in the art that a number of variations and modifications can be made without departing from the scope of the invention as defined in the claims.

All citations are hereby incorporated by reference.

### GLOSSARY & DATA

### ⁽¹⁾ State Function

In thermodynamics, a state function is a property of a system that depends only on the current state of the system, not on the way in which the system acquired that state (independent of path). A state function describes the equilibrium state of a system.

State functions are a function of the parameters of the system, which only depends upon the parameters' values at the endpoints of the path. Temperature, pressure, internal or elastic potential energy, enthalpy and entropy are state quantities because they describe quantitatively an equilibrium state of a thermodynamic system, irrespective of how the system arrived in that state.

It is best to think of state functions as quantities or properties of a thermodynamic system, while non-state functions represent a process during which the state functions change. For example, in this document, the state function W=PV (“PV”=pressure multiplied by volume) varies proportionally to the internal energy of a fluid during the path in the system, but the work “W” is the amount of energy transferred as the system performs work: internal energy like the elastic potential energy is identifiable, it is a particular form of energy; work is the amount of energy that has changed its form or location.

### ⁽²⁾ Working Fluid

In the following descriptions and references, the Working Fluid generally is made of compound substances, often organic or refrigerants, characterized by a state of matter which varies according to the Ambient Temperature and Ambient Pressure related to reversible phase changes from gas to liquid and reverse.

### EXAMPLES

Many compound substances and refrigerants are blends of other compounds. The properties of a blend are modified easily by changing the proportions of the constituents.

In many countries, use of refrigerants as a Working Fluid is regulated. Refrigerants were traditionally fluorocarbons, especially chlorofluorocarbons, but these are being phased out because of their ozone depletion effects. Other common refrigerants now used in various applications are near-azeotropic mixtures (like R-410A=HFC-32/HFC-125), fluoryl, ammonia, sulfur dioxide and non-halogenated hydrocarbons.

Of course, other standard compound and organic substances may be used instead, such as butane, propane or methane, or chemical elements like nitrogen and oxygen and compounds such as nitrous oxide and carbon dioxide, and new Working Fluids may be engineered with properties optimized to a specific design scenario of the Pressure Power System 100 (e.g. for enabling lower or higher Ambient Temperatures in the cold sub-system 105 and warm sub-system 110 but still offering similar workable Ambient Pressures).

The properties of a number of suitable Working Fluids are presented herein.

### ⁽³⁾ Normal Boiling Point

The boiling point of a liquid is the temperature at which the vapor pressure of the liquid equals the Ambient Pressure (i.e. the environmental pressure surrounding the liquid) and the liquid changes into vapor.
The Normal Boiling Point of a liquid is the special case in which the vapor pressure of the liquid equals the defined atmospheric pressure at sea level, i.e. 1 atmosphere (1.013 bar). At that temperature, the vapor pressure of the liquid becomes sufficient to overcome atmospheric pressure and allow bubbles of vapor to form inside the bulk of the liquid (i.e. the vaporization).
In the Pressure Power System 100, the Ambient Temperature and Ambient Pressure of the Working Fluid determining the boiling point in the cold sub-system 105 are considered as the reference level of the “Normal State Function” of the system.

### ⁽⁴⁾ Work Extraction

In contrast to the state function, mechanical work and heat are process quantities because their values depend on the specific transition (or path) between two equilibrium states.

In other words, the work extraction within a pressure system corresponds to the negative change in its internal energy, as determined by the change of the state function of the system when expanding volume: the system releases stored internal energy when doing work on its surroundings.

In physics, work is a scalar quantity that can be described as the product of a force times the distance through which it acts, and it is called the work of the force.

As the first law of thermodynamics states that energy can be transformed (i.e. changed from one form to another), the change in the internal energy of a system is equal to the amount of heat supplied to the system (thermal energy), minus the amount of work extraction done by the system exerting work on its surroundings.

In Pressure Systems, where the temperature and pressure are held constant, the amount of useful work which may be extracted is determined by the state function of the system corresponding to the volume and the state of matter of the substance it contains.

### ⁽⁵⁾ Ambient Temperature

In the following descriptions and references, Ambient Temperature means the temperature of a Working Fluid, within a surrounding device, such as the temperature in a container, piece of equipment or component in a process or system.

### ⁽⁶⁾ Surrounding Temperature

In the following descriptions and references, the Surrounding Temperature means:
(i) the current temperature of the outdoors, in the atmosphere, at any particular time of day or night, or the temperature found in water flow such as seas, lakes, rivers, sea beds, aquifers or groundwater sources, and
(ii) the room temperature indoors (often called “room temperature”) including but not limited to:
   the temperature inside a building or structure such as in an office building, apartment complex or house, which may or may not be temperature controlled;
   the temperature inside a manufacturing or industrial facility, including where the temperature is hotter because of the heat generated from operations such as a foundry, manufacturing, pulp & paper, textiles, commercial kitchens & bakeries, or laundries and dry cleaning;
   the temperature at certain depths in mine shafts with or without active mining operations;
   the temperature in a greenhouse, shed or other complex specifically built to house equipment.

### ⁽⁷⁾ Forms of Energy

The thermal energy is distinct from heat. In its strict use in physics, heat is a characteristic only of a process, i.e. it is absorbed or produced as an energy exchange, but it is not a static property of matter. Matter does not contain heat rather thermal energy. Heat is thermal energy in the process of transfer or conversion across a boundary of one region of matter to another.
The internal energy, in thermodynamics, is the total energy contained by a thermodynamic system. It is the energy needed to create the system but excludes the energy to displace the system's surroundings, any energy associated with a move as a whole, or due to external force fields. Internal energy has two major components, kinetic energy and potential energy. The internal energy of a system can be changed by heating the system or by doing work on it; the first law of thermodynamics states that the increase in internal energy is equal to the total heat added and work done by the surroundings. If the system is isolated from its surroundings, its internal energy cannot change.
The kinetic energy of an object or a substance is part of the mechanical energy which it possesses due to its motion. It is defined as the work needed to accelerate a body of a given mass from rest to its stated velocity. Having gained this energy during its acceleration, the body maintains this kinetic energy unless its speed changes. The same amount of work is done by the body in decelerating from its current speed to a state of rest.
The speed, and thus the kinetic energy of a substance, is frame-dependent (relative): it can take any non-negative value, by choosing a suitable inertial frame of reference.
The potential energy is the energy stored in a material, in a body or in a system due to its state of matter, its position in a force field or due to its configuration. There are various types of potential energy, each associated with a particular type of force. More specifically, every conservative force gives rise to potential energy. For example, the work of an elastic force is called elastic potential energy.
The elastic energy is considering generally the potential mechanical energy stored, in a system (corresponding to its state function) or a material contained by a physical system, as work by distorting its volume or shape. The concept of elastic energy is not confined to formal elasticity theory which primarily develops an analytical understanding of the mechanics of solid bodies and materials.
The essence of elasticity is reversibility. Forces applied to an elastic material transfer energy into the material which, upon yielding that energy to its surroundings, can recover its original shape or volume.
Although elasticity is associated most commonly with the mechanics of solid bodies or materials, even the early literature on classical thermodynamics defines and uses “elasticity of a fluid” in ways compatible with the broad definition provided here above:

Elastic Potential Energy in Compressible and Pressurized Gases and Liquids
The present invention is based on said “elasticity of a fluid” in ways compatible with conversion of its elastic potential energy into work:
   The behavior of a fluid in a system, where its Ambient Pressure/Temperature represents its elastic potential energy, means that the phase transition of the fluid from its liquid state, (hereinafter also referred to as “liquid”), to its gaseous state, (hereinafter referred to as “vapor” or “gas”), and reverse, modifies the state function of the system.
   Opposing two different states of matter of a material in two separate systems (e.g. having different state functions with singular Ambient Temperature/Pressure relations) by linking them together creates a pressure differential allowing conversion of energy (i.e. production of work) by pushing on an expandable pressure device (for example, comprised of a piston in a cylinder), similar to a system using mechanical compressed gas for actuating an engine and thereby transforming its elastic potential energy into kinetic energy.

### ⁽⁸⁾ Ambient Pressure

In the following descriptions and references, the Ambient Pressure of a system is the pressure of a Working Fluid, exerted on its immediate surroundings, which may be a container, particular device, piece of equipment or component in a process or system.

The Ambient Pressure varies as a direct relation to the Ambient Temperature of the Working Fluid and corresponds to the elastic potential energy that the substance renders at particular states of matter of equilibrium vapor pressure, as determined by the substance's phase change characteristics.

### ⁽⁹⁾ Equilibrium Vapor Pressure

The equilibrium vapor pressure is the Ambient Pressure exerted by a vapor in thermodynamic equilibrium with its condensed phases (solid or liquid) at a given temperature in a closed system. The equilibrium vapor pressure is an indication of a liquid's vaporization rate. It relates to the tendency of particles to escape from the liquid (or a solid). A substance with a high vapor pressure at normal temperatures is often referred to as volatile.

The vapor pressure of any substance increases non-linearly with temperature according to the Clausius-Clapeyron relation. The atmospheric pressure boiling point of a liquid (also known as the normal boiling point) is the temperature at which the vapor pressure equals the ambient atmospheric pressure. With any incremental increase in that temperature, the vapor pressure becomes sufficient to overcome atmospheric pressure and lift the liquid to form vapor bubbles inside the bulk of the substance. Bubble formation deeper in the liquid requires a higher pressure, and therefore higher temperature, because the fluid pressure increases above the atmospheric pressure as the depth increases.

### ⁽¹⁰⁾ Vaporization

Vaporization of an element or compound is a phase transition from the liquid phase to gas phase. There are two types of vaporization: evaporation and boiling. However, in the Pressure Power System 100, mainly the evaporation is considered as the phase transition from the liquid phase to gas phase that occurs at temperatures below the boiling temperature at a given pressure. Evaporation usually occurs on the surface.

### ⁽¹¹⁾ Liquefaction

Liquefaction is referred to as liquefaction of gases, i.e. the process of condensing a gas into a liquid. In the Pressure Power System 100, liquefaction corresponds to the change from the gaseous form to the liquid form of the Working Fluid through condensation, usually by cooling combined with small compression processes.

### ⁽¹²⁾ Phases

In bulk, matter can exist in several different forms, or states of aggregation, known as phases, depending on Ambient Pressure, temperature and volume. A phase is a form of matter that has a relatively uniform chemical composition and physical properties (such as density, specific heat, refractive index, pressure and so forth) which, in a particular system, determine its state function.

Phases are sometimes called states of matter, but this term can lead to confusion with thermodynamic states. For example, two gases maintained at different pressures are in different thermodynamic states (different pressures), but in the same phase (both are gases). The state or phase of a given set of matter can change depending on Ambient Pressure and Ambient Temperature conditions as determined by their specific conditions of state function, transitioning to other phases as these conditions change to favor their existence. For example, liquid transitions to gas with an increase in temperature.

### ⁽¹³⁾ Volatility

Volatility is the tendency of a substance to vaporize. Volatility is related directly to a substance's vapor pressure. At a given temperature, a substance with a higher vapor pressure vaporizes more readily than a substance with a lower vapor pressure, and therefore the higher the vapor pressure of a liquid at a given temperature, the higher the volatility and the lower the normal boiling point of the liquid.

### ⁽¹⁴⁾ State of Matter

States of matter are the distinct forms that different phases of matter take on. Solid, liquid and gas are the most common states of matter.

States of matter also may be defined in terms of phase transitions. A phase transition indicates a change in structure and can be recognized by an abrupt change in properties. By this definition, a distinct state of matter is any set of states distinguished from any other set of states by a phase transition.

The state or phase of a given set of matter can change depending on the state function of the system (Ambient Pressure and Ambient Temperature conditions), transitioning to other phases as these conditions change to favor their existence; for example, liquid transitions to gas and reverse with an increase/decrease in Ambient Temperature or Ambient Pressure.

Distinctions between states are based on differences in molecular interrelationships: liquid is the state in which intermolecular attractions keep molecules in proximity, but do not keep the molecules in fixed relationships, which is able to conform to the shape of its container but retains a (nearly) constant volume independent of pressure; gas is that state in which the molecules are comparatively separated and intermolecular attractions have relatively little effect on their respective motions, which has no definite shape or volume, but occupies the entire pressure device in which it is confined by reducing/increasing its Ambient Pressure/Temperature.

### ⁽¹⁵⁾ ISMC=ISO 13443:

International Standard Metric Conditions of temperature, pressure and humidity (state of saturation), used for measurements and calculations carried out on natural gases, natural-gas substitutes and similar fluids in the gaseous state, are 288.15 K (15° C.) and 101.325 kPa (1 Atm).

### ⁽¹⁶⁾ Clausius-Clapeyron Relation:

Named after Rudolf Clausius and Benoit Paul Emile Clapeyron, the relation is a way of characterizing a discontinuous phase transition between two phases of matter of a single substance. On a pressure-temperature (P-T) diagram, the line separating the two phases is known as the coexistence curve. The Clausius-Clapeyron relation gives the slope of the tangents to this curve. Mathematically,

$$\frac{d P}{d T} = \frac{L}{T Δ v}$$

where dP/dT is the slope of tangent to the coexistence curve at any point, L is the specific latent heat, T is the temperature, and Δv is the specific volume change of the phase transition.

### ⁽¹⁷⁾ Joule-Thomson Effect

In thermodynamics, the Joule-Thomson effect or Joule-Kelvin effect or Kelvin-Joule effect or Joule-Thomson expansion, in which a gas undergoes free expansion in a vacuum, describes the temperature change of a gas or liquid when it is forced through a valve or porous plug while kept insulated so that no heat is exchanged with the environment. This procedure is called a throttling process or Joule-Thomson process. At room temperature, all gases except hydrogen, helium and neon cool upon expansion by the Joule-Thomson process.

What is claimed is:

1. A Pressure Power System comprising:
a cold sub-system;
a warm sub-system;
a work extraction system; and
a hydraulic pump;
said cold sub-system, said warm sub-system, said work extraction system, and said hydraulic pump being arranged in a closed loop;
said cold sub-system and said warm sub-system being respectively maintained at lower and higher temperatures relative to one another;
a Working Fluid circulating cyclically in said closed loop between said cold sub-system and a warm sub-system, said Working Fluid having different equilibrium vapor pressures in said cold sub-system and said warm sub-system, according to the respective state function, representing two different levels of elastic potential energy which results in a pressure differential between said cold sub-system and said warm sub-system;
said work extraction system being positioned between the outlet of said warm sub-system and the inlet of said cold sub-system, and being operable to convert said elastic potential energy/pressure differential into kinetic energy; and
said hydraulic pump being positioned between the outlet of said cold sub-system and the inlet of said warm sub-system, and being operable to circulate liquid Working Fluid back from the cold sub-system to the warm sub-system.

2. The Pressure Power System of claim 1, wherein said Working Fluid is stored at a warmer temperature in the warm sub-system than in the cold sub-system, the temperature differential between the cold and warm sub-systems being sufficient to determine two different state functions, where the equilibrium vapor pressure of the Working Fluid in the warm sub-system versus the equilibrium vapor pressure of the Working Fluid in the cold sub-system causes an exploitable pressure differential enabling extraction of work.

3. The Pressure Power System of claim 1, wherein the substance of said Working Fluid (or compound) enables its state of matter to vary by reversible phase change from gas to liquid and reverse.

4. The Pressure Power System of claim 1, wherein said cold sub-system causes most of the Working Fluid to liquefy.

5. The Pressure Power System of claim 4, wherein said cold sub-system comprises a pressure vessel.

6. The Pressure Power System of claim 5, wherein said pressure vessel enlarges the volume of said cold sub-system, enabling free expansion of the Working Fluid in its gaseous form to about atmospheric pressure.

7. The Pressure Power System of claim 1, wherein said cold sub-system comprises an expansion chamber.

8. The Pressure Power System of claim 7, wherein said cold sub-system comprises a condenser wherein part of the gaseous Working Fluid liquefies, thereby enabling said Working Fluid to keep constant its vapor/liquid equilibrium at an Ambient Temperature a little above its NBP.

9. The Pressure Power System of claim 8, wherein said cold sub-system condenser comprises a pressure vessel, functioning as a storage container.

10. The Pressure Power System of claim 1, wherein said cold sub-system is insulated.

11. The Pressure Power System of claim 1, wherein said cold sub-system comprises an active spray system.

12. The Pressure Power System of claim 8, wherein said cold sub-system comprises a pump/vacuum system for transferring said Working Fluid from said expansion chamber to said condenser.

13. The Pressure Power System of claim 1, wherein said Working Fluid is stored at a temperature close to and above its NBP in the cold sub-system.

14. The Pressure Power System of claim 1, further comprising a pump to transfer said Working Fluid in a liquid state, from the output of said cold sub-system to the input of said warm sub-system.

15. The Pressure Power System of claim 1, wherein said warm sub-system causes most of the Working Fluid to vaporize.

16. The Pressure Power System of claim 15, wherein said warm sub-system comprises a pressure vessel, functioning as a storage container.

17. The Pressure Power System of claim 1, wherein the state functions of both warm and cold sub-systems are maintained constant to make the volatility of the Working Fluid stay at the respective vapor/liquid equilibrium, at which the gaseous phase (“vapor”) is in equilibrium with its liquid phase, so that it only partially fills said pressure vessels in the liquid state of matter, the rest of each vessel being filled with the Working Fluid in a pressurized gaseous state.

18. The Pressure Power System of claim 1, wherein said warm sub-system collects surrounding heat energy to maintain its Ambient Temperature, and to effect the Working Fluid with elastic potential energy by vaporizing some of the liquid phase of the Working Fluid into pressurized vapor.

19. The Pressure Power System of claim 1, wherein said warm sub-system comprises one or more heat exchangers.

20. The Pressure Power System of claim 19, wherein said one or more heat exchangers are warmed by their surrounding temperature.

21. The Pressure Power System of claim 1, wherein said warm sub-system is warmed by energy sources selected from the group consisting of: thermal solar; geothermal; wind; biomass; fuel cells; water flows such as rivers, sea beds, aquifers or groundwater sources; heat gradient found underground, for example, in mine shafts and in the basements of buildings; commercial or industrial heat recovery systems; greenhouses; and ambient temperature found in the atmosphere not immediately surrounding or in industrial buildings.

22. The Pressure Power System of claim 19, wherein said one or more heat exchangers are warmed by an external heater, possibly fueled by propane, natural gas or another fossil fuel.

23. The Pressure Power System of claim 1, wherein said warm sub-system possibly collects energy from multiple surrounding heat energy sources which may be located at a distance from the Pressure Power System, enabling the exploitation of the Pressure Power System to work as a hybrid.

24. The Pressure Power System of claim 1, wherein said warm sub-system is maintained at the temperature of the immediate surroundings.

25. The Pressure Power System of claim 1, wherein said warm sub-system is maintained below the critical point of said Working Fluid.

26. The Pressure Power System of claim 1, wherein said Working Fluid is selected from the group consisting of: an organic material, a compound, a blend of compounds, refrigerants, ammonia, sulfur dioxide, non-halogenated hydrocarbons such as fluoryl, propane, and methane, chemical elements like nitrogen and compounds such as carbon dioxide and nitrous oxide.

27. The Pressure Power System of claim 1, wherein said Working Fluid has a Normal Boiling Point (NBP) notably below the ‘ISMO’ temperature (International Standard Metric Conditions of temperature, pressure and humidity or state of saturation: 288,15° K [15° C.] and 101,325 kPa [1 Atm]).
